(19) United States
(12) Patent Application Publication
(10) Pub. No.: US 2021/0339177 A1
(43) Pub. Date: Nov. 4, 2021

(54) DUST COLLECTING FILTER AND PROCESS FOR MANUFACTURING THE SAME

(71) Applicant: COWAY Co., Ltd., Gongju-si (KR)

(72) Inventors: Hyun Jun YUN, Seoul (KR); Byong Hyoek LEE, Seoul (KR); Jong Cheol KIM, Seoul (KR)

(73) Assignee: COWAY Co., Ltd., Gongju-si (KR)

(21) Appl. No.: 17/104,600

(22) Filed: Nov. 25, 2020

(30) Foreign Application Priority Data
Apr. 29, 2020 (KR) 10-2020-0052710

(51) Int. Cl. B01D 39/16

(52) U.S. Cl. CPC B01D 39/1623; B01D 2239/10; B01D 2239/065; B01D 39/1692

(57) ABSTRACT

The present invention relates to a dust collecting filter and a process for manufacturing the same. Specifically, according to an embodiment of the present invention, the filter medium contained in a dust collecting filter comprises a first nonwoven fabric layer, a porous layer, a second nonwoven fabric layer, and a polypropylene melt-blown layer sequentially laminated, wherein the melt-blown layer has a melt index and a basis weight in specific ranges, and the first nonwoven fabric layer and the second nonwoven fabric layer have a sum of the basis weights in a certain range, whereby it is possible to enhance the sustainability, processability, and bendability of the filter medium, enhance the workability at high temperatures and adhesion, and further enhance the durability and life span characteristics of the filter.

### TECHNICAL FIELD

The present invention relates to a dust collecting filter and a process for manufacturing the same.

### BACKGROUND ART

In general, an air purifier or air purifying device provides fresh air by filtering out polluted dust or substances harmful to the human body in the air by applying various filter systems. It is used in various fields such as houses, vehicles, clean rooms, and hospitals to maintain a pleasant indoor environment.

Various dust collecting filters adopting a filter medium for removing particulate pollutants contained in a gas are used in such filter systems.

In general, a filter medium provided with a polytetrafluoroethylene (PTFE) membrane or a filter medium employing a melt-blown nonwoven fabric is used in such dust collecting filters.

A filter medium provided with a PTFE membrane among the above has a problem in that the PTFE membrane is a very thin material having high flexibility and low strength, so that it has poor processability, handling convenience, and productivity. In addition, a PTFE membrane has a problem in that since it has a microporous structure, particles larger than the pores would accumulate on the filter surface to form a dust cake and block the pores to increase the pressure loss of the filter, thereby reducing the life span characteristics of the filter.

Meanwhile, when dust accumulates in a filter medium composed of a melt-blown nonwoven fabric, the electrical charge of the filter is gradually increased, and the dust collecting efficiency is reduced, thereby deteriorating the life span characteristics of the filter.

Accordingly, it is still necessary to develop a dust collecting filter that not only has excellent processability, handling convenience, and productivity, but can also satisfy high performance and high life span characteristics while maintaining a high efficiency of removing particulate pollutants in the air.

### PRIOR ART DOCUMENT

### Patent Document

(Patent Document 1) Korean Laid-open Patent Publication No. 2010-0032659

### DETAILED DESCRIPTION OF THE INVENTION

### Technical Problem

An object of the present invention is to provide a dust collecting filter that comprises a filter medium comprising a first nonwoven fabric layer, a porous layer, a second nonwoven fabric layer, and a polypropylene melt-blown layer sequentially laminated, wherein the melt-blown layer has a melt index and a basis weight in specific ranges, and the first nonwoven fabric layer and the second nonwoven fabric layer comprise polyethylene terephthalate (PET) and have a sum of the basis weights in a certain range, and a process for manufacturing the same. Thus, it is possible to enhance the processability and bendability, enhance the workability at high temperatures and adhesion, and maintain a high dust collection efficiency for fine particles while solving the problem that the difference in differential pressure rapidly changes as particles accumulate in the filter, thereby further enhancing the durability and life span characteristics of the filter.

### Solution to the Problem

The present invention provides a dust collecting filter formed by bending a filter medium, wherein the filter medium comprises a first polyester-based nonwoven fabric layer; a porous layer disposed on the upper side of the first nonwoven fabric layer; a second polyester-based nonwoven fabric layer disposed on the upper side of the porous layer; and a polypropylene-based melt-blown layer disposed on the upper side of the second nonwoven fabric layer, the porous layer comprises a polytetrafluoroethylene (PTFE) resin, the first nonwoven fabric layer and the second nonwoven fabric layer comprise polyethylene terephthalate (PET), the melt-blown layer comprises polypropylene having a melt index of 800 g/10 minutes to 1,500 g/10 minutes at 265° C., the sum of the basis weights of the first nonwoven fabric layer and the second nonwoven fabric layer is 35 gsm to 85 gsm, and the basis weight of the melt-blown layer is 20 gsm to 40 gsm.

In addition, the present invention provides a process for manufacturing a dust collecting filter, which comprises a first step of laminating a first polyester-based nonwoven fabric layer and a second polyester nonwoven fabric layer on the lower and upper sides of a porous layer, respectively; and a second step of laminating a polypropylene-based melt-blown layer on the upper side of the second non-woven fabric layer, wherein the porous layer comprises a polytetrafluoroethylene (PTFE) resin, the first nonwoven fabric layer and the second nonwoven fabric layer comprise polyethylene terephthalate (PET), the melt-blown layer comprises polypropylene having a melt index of 800 g/10 minutes to 1,500 g/10 minutes at 265° C., the sum of the basis weights of the first nonwoven fabric layer and the second nonwoven fabric layer is 35 gsm to 85 gsm, and the basis weight of the melt-blown layer is 20 gsm to 40 gsm.

### Advantageous Effects of the Invention

According to an embodiment of the present invention, it is possible to further enhance the durability and life span characteristics of a filter while maintaining a high dust collection efficiency for fine particles.

Further, the filter medium is excellent in sustainability, processability, and bendability, and it is possible to further enhance the workability at high temperatures and adhesion between the respective constituent layers.

### BRIEF DESCRIPTION OF THE DRAWING

FIG. 1 is a perspective view conceptually showing a dust collecting filter according to an embodiment of the present invention.

FIG. 2 is a cross-sectional view taken along line A-A′ in FIG. 1 and an enlarged view thereof.

FIG. 3 is a cross-sectional view taken along line B-B′ in FIG. 2.

FIG. 4 is a graph showing the differential pressure with respect to the amount of dust supplied in Example 1 and Comparative Examples 1 and 2.

FIG. 5 is a graph showing the variation in differential pressure with respect to the amount of dust supplied in Example 1 and Comparative Examples 1 and 2.

FIG. 6 is a graph showing the dust collection efficiency with respect to the amount of diethylhexyl sebacate (DEHS) supplied in Example 1 and Comparative Example 1.

### BEST MODE FOR CARRYING OUT THE INVENTION

Hereinafter, the present invention will be described in more detail.

In addition, specific embodiments for implementing the idea of the present invention will be described in detail with reference to the drawings.

Further, when it is determined that a detailed description of a related known constitution or function may obscure the gist of the present invention in describing the present invention, a detailed description thereof will be omitted.

In addition, some components are exaggerated, omitted, or schematically illustrated in the accompanying drawings, and the size of each component does not entirely reflect the actual size.

The terms used in this specification are only used to describe specific embodiments and are not intended to limit the present invention. Singular expressions encompass plural expressions unless the context clearly indicates otherwise.

In addition, terms including ordinal numbers, such as first and second, may be used to describe various elements, but the corresponding elements are not limited by these terms. These terms are used only for the purpose of distinguishing one component from another.

In the present specification, the same reference numeral refers to the same element.

In addition, as used herein, the meaning of “comprising” specifies a specific characteristic, region, integer, step, action, element, and/or component, and it does not exclude the presence or addition of other specific characteristics, regions, integers, steps, actions, elements, components, and/or groups.

Hereinafter, a filter medium (200) according to an embodiment of the present invention will be described. The filter medium (200) may be provided to a dust collecting filter (100).

Dust Collecting Filter

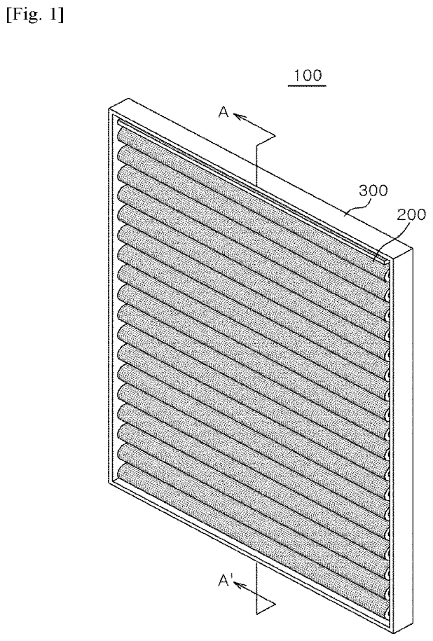

Referring to FIG. 1, the dust collecting filter (100) may comprise a housing (300) and a bent filter medium (200) disposed inside the housing (300).

Housing

The housing (300) may serve as a frame for supporting the filter medium (200).

The housing (300) may be assembled or molded so that the filter medium (200) may be properly disposed and mounted. The shape (or structure) of the housing (300) may be arbitrarily determined according to the purpose of use or environment.

The material of the housing (300) may be a material of a conventional housing used for a dust collecting filter.

Specifically, at least one selected from the group consisting of an acrylonitrile-butadiene-styrene copolymer (ABS), polypropylene (PP), paper, nonwoven fabrics, polycarbonate (PC), and elastomer resins may be used as a material of the housing (300). Specifically, ABS or PP may be used as the material of the housing (300), and ABS may be used in consideration of the fact that dimensional accuracy can be readily secured and deformation during use can be suppressed. In addition, since polyethylene terephthalate (PET) and ABS have high adhesion (or melt adhesion) to each other, if a dust collecting filter is manufactured by using PET as the first nonwoven fabric layer and/or the second nonwoven fabric layer and using ABS as the housing, it is possible to prevent separation of the filter medium (200) and the housing (300).

Filter Medium

The filter medium (200) has excellent permeability for air, thereby minimizing a pressure loss due to the installation of a filter, and can function as a filtration unit capable of filtering fine dust while allowing air alone to pass.

The filter medium (200) comprises a first polyester-based nonwoven fabric layer (230a); a porous layer (210) disposed on the upper side of the first nonwoven fabric layer (230a); a second polyester-based nonwoven fabric layer (230b) disposed on the upper side of the porous layer; and a polypropylene-based melt-blown layer (220) disposed on the upper side of the second nonwoven fabric layer (230b), wherein the porous layer (210) comprises a polytetrafluoroethylene (PTFE) resin, the first nonwoven fabric layer (230a) and the second nonwoven fabric layer (230b) comprise polyethylene terephthalate (PET), the melt-blown layer (220) comprises polypropylene having a melt index of 800 g/10 minutes to 1,500 g/10 minutes at 265° C., the sum of the basis weights of the first nonwoven fabric layer (230a) and the second nonwoven fabric layer (230b) is 35 gsm to 85 gsm, and the basis weight of the melt-blown layer (220) is 20 gsm to 40 gsm.

According to an embodiment of the present invention, the first nonwoven fabric layer (230a) and the second nonwoven fabric layer (230b) are disposed on the lower and upper sides of the porous layer (210), respectively, and the first nonwoven fabric layer (230a) and the second nonwoven fabric layer (230b) comprise PET, whereby it is possible to enhance the workability at high temperatures, processability, and bendability of the filter medium. In particular, as the first nonwoven fabric layer (230a) and the second nonwoven fabric layer (230b) satisfy the sum of the basis weights in a specific range, the adhesion of the respective layers employed in the filter medium, the bendability of the filter medium, the sustainability of the filter, and the durability of the filter can be enhanced. The sum of the basis weights of the first nonwoven fabric layer (230a) and the second nonwoven fabric layer (230b) may vary with the characteristics of the porous layer (210) or the characteristics of the polypropylene-based melt-blown layer (220), which may be appropriately adjusted to control the above characteristics of the filter medium.

Further, as the filter medium (200) comprises the porous layer (210) and the polypropylene-based melt-blown layer (220) together, particulate contaminants including dust or oil in the air are firstly removed by the polypropylene-based melt-blown layer (220) and secondly removed by the porous layer (210), it is possible to maintain a high dust collection efficiency and to operate with a difference in the differential pressure controlled in an appropriate range at the same time, thereby further enhancing the life span characteristics and durability of the filter.

The filter medium (200) may be disposed inside the housing (300) by molding.

The filter medium according to an embodiment of the present invention may be formed as bent in a dust collecting filter. If the filter medium is formed as bent in a dust collecting filter, the filtration area is wide to reduce the pressure loss and increase the life span of the filter. In addition, if the filter medium is formed as bent in a dust collecting filter, the structure is firm, resulting in an advantage that it can be used for a long period of time.

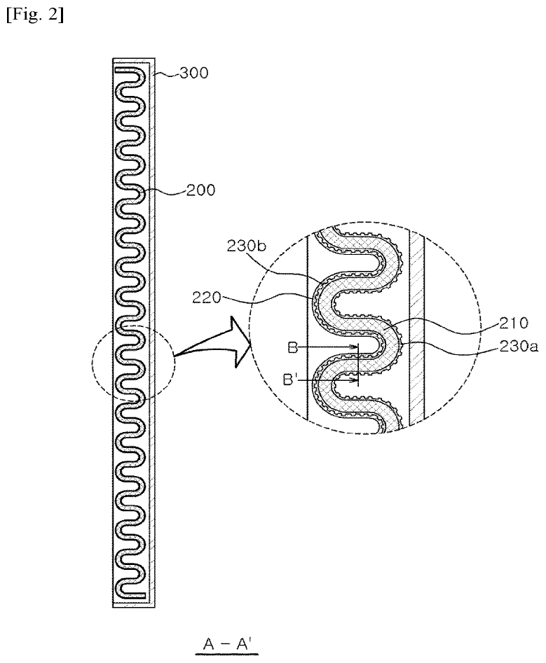

Referring to FIG. 2, the filter medium (200) may be bent in a pleated shape and disposed in the housing (300). For example, the pleated shape may be a structure in which pleats are formed by bending. In addition, the shape of the pleats may vary, such as a zigzag type angular pleat or rounded pleat. The shape and size of the pleats are not particularly limited.

In addition, the height of the peaks of the pleats may be 10 mm to 60 mm. Here, the height of the peaks may refer to the amplitude of the pleats, that is, the distance between the peak and the valley. In addition, the distance between the peaks may be 2 mm to 8 mm.

In addition, the filter medium (200) may not be processed to be pleated.

Hereinafter, each layer employed in the filter medium will be described in detail.

Porous Layer

The porous layer (210) plays a major role in the dust collecting performance and comprises a PTFE resin. In addition, the porous layer (210) may be formed in a microporous structure.

The porous layer (210) may be prepared by a porosification method conventionally used in which a PTFE resin is used to fabricate a PTFE molded body in a sheet shape and it is then stretched.

For example, a liquid lubricant is added to PTFE fine powder to preform a pasty mixture. The liquid lubricant is not particularly limited as long as it can wet the surface of the PTFE fine powder and can be removed by extraction or heating. For example, hydrocarbons such as liquid paraffin, naphtha, or white oil may be used. Subsequently, the preform may be molded into a sheet by paste extrusion or rolling, and the PTFE molded body thus obtained is stretched in at least one axial direction to form a PTFE porous layer.

The stretching of the PTFE molded body may be carried out after the liquid lubricant is removed. In addition, the stretching conditions of the PTFE molded body may be appropriately determined. In general, both of stretching in the longitudinal direction and stretching in the transverse direction may be carried out at a stretching ratio of 2 to 30 times at a temperature in a range of 30° C. to 320° C. After the stretching, the porous PTFE layer may be plasticized by heating above the melting point of PTFE.

In addition, a filler or the like may be added when the molded body is preformed. For example, a conductive material such as carbon particles or metal powder may be added as a filler to form an antistatic porous PTFE layer.

As long as the porous layer (210) is a porous layer having appropriate performance as a filter, its structure or configuration is not particularly limited. For example, the porous layer (210) may have an average pore (hole) diameter of 0.01 μm to 5 μm, 0.02 μm to 4 μm, or 0.05 μm to 3 μm.

The porous layer (210) may have a porosity of 70% to 98%, 80% to 98%, or 85 to 96%. In addition, the porous layer (210) may have a structure in which two or more porous layers are laminated. The porous layer (210) may have a thickness of 1 μm to 10 μm, 2 μm to 8 μm, or 2 μm to 6 μm.

The porous layer (210) has a most penetrated particle size (MPPS) of 95% or more, 96% or more, 97% or more, 98% or more, or 99% or more, as measured by air permeation at a flow rate of 5.3 cm/second using paraffin oil having a particle size of 0.05 to 1 μm. In addition, the porous PTFE layer (210) may have a most penetrated particle size of 99.95% or less, 99.93% or less, or 99.92% or less.

The pressure loss of the porous layer is not particularly limited. The pressure loss when air is permeated at a flow rate of 5.3 cm/second may be 50 Pa to 1,000 Pa, 50 Pa to 500 Pa, 50 Pa to 200 Pa, or 50 Pa to 100 Pa.

First Polyester-Based Nonwoven Fabric Layer

The first polyester-based nonwoven fabric layer (230a) (hereinafter referred to as the first nonwoven fabric layer) is disposed on one side (lower side) of the porous layer (210) and serves as a support layer to enhance the processability, handling convenience, and permeability for air.

Since the porous layer (210) is of a very thin material having high flexibility and low strength, if the first nonwoven fabric layer (230a) serving as a support layer is not disposed on one side of the porous layer (210), the filter medium may be easily deformed by external pressure, during the manufacturing process, or by air input when the filter is used, it is difficult to be processed, and the adhesion and productivity may be deteriorated.

The first nonwoven fabric layer (230a) may comprise polyethylene terephthalate (PET) having excellent thermal resistance. If the first nonwoven fabric layer (230a) comprises PET having excellent thermal resistance, it is possible to minimize the deterioration in the performance after lamination by heating and to further enhance the adhesion to the porous layer (210).

The first nonwoven fabric layer (230a) may have a basis weight of 20 gsm to 60 gsm or 20 gsm to 30 gsm. The basis weight is measured as a gram per square meter, and it is a unit representing the weight of a fabric having an area of 1 m in width and 1 m in length. Thus, the larger the basis weight, the heavier or thicker the first nonwoven fabric layer.

The basis weight of the first nonwoven fabric layer (230a) may vary with the characteristics of the porous layer (210) or the characteristics of the polypropylene-based melt-blown layer (220). It is very important to properly adjust the same. As the basis weight of the first nonwoven fabric layer (230a) satisfies the above range, the sustainability, processability, and bendability of the filter medium may be enhanced, and the workability at high temperatures and adhesion may be enhanced.

Second Polyester-Based Nonwoven Fabric Layer

The second polyester-based nonwoven fabric layer (230b) (hereinafter referred to as the second nonwoven fabric layer) is disposed on the other side (upper side) of the porous layer (210) and serves as a support layer to enhance the processability and permeability for air. If the second nonwoven fabric layer (230b) serving as a support layer is not disposed on the upper side of the porous layer (210), the filter medium may be easily deformed by external pressure, during the manufacturing process, or by air input when the filter is used, it is difficult to be processed, and the productivity may be deteriorated.

The second nonwoven fabric layer (230b) may comprise PET having excellent thermal resistance.

The second nonwoven fabric layer (230b) may have a basis weight of, for example, 15 gsm to 50 gsm, for example, 20 gsm to 50 gsm, for example, 20 gsm to 30 gsm.

The basis weight of the second nonwoven fabric layer (230b) may vary with the characteristics of the porous layer (210) or the characteristics of the polypropylene-based melt-blown layer (220). It is very important to properly adjust the same. As the basis weight of the second nonwoven fabric layer (230b) satisfies the above range, the sustainability, processability, and bendability of the filter medium may be enhanced, and the workability at high temperatures and adhesion may be enhanced.

The sum of the basis weight of the first nonwoven fabric layer (230a) and the basis weight of the second nonwoven fabric layer (230b) may be 35 gsm to 85 gsm, for example, 40 gsm to 80 gsm, or, for example, 50 gsm to 80 gsm. If the sum of the basis weight of the first nonwoven fabric layer (230a) and the basis weight of the second nonwoven fabric layer (230b) is less than 35 gsm, the porous layer (210) may not be properly supported, resulting in damage such as tearing, and the bendability of the filter medium may be deteriorated. In addition, a filter is generally manufactured by bending the filter media in a zigzag shape. If the sum of the basis weight of the first nonwoven fabric layer (230a) and the basis weight of the second nonwoven fabric layer (230b) exceeds 85 gsm, there may be difficulties in such bending and processing.

Polypropylene-Based Melt-Blown Layer

Meanwhile, the polypropylene-based melt-blown layer (220) contains ultrafine fibers having a high collection efficiency even when the size of fine dust particles is several microns or less. Thus, particles smaller than the pores can also be removed by using electrostatic, thereby increasing the removal efficiency of pollutants, and it can play a role of enabling operation with a low pressure loss and low differential pressure since large pores are formed.

If the filter medium does not comprise the polypropylene-based melt-blown layer (220), the pressure increases as the amount of dust or contaminants increases, resulting in increased power consumption, shortened life span of the filter, and reduced durability.

The polypropylene-based melt-blown layer (220) is disposed on the upper side of the second nonwoven fabric layer (230b).

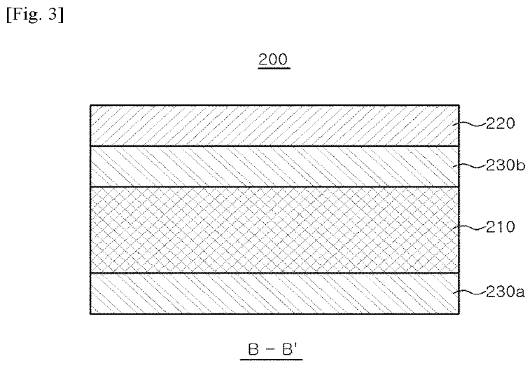

In particular, if the polypropylene-based melt-blown layer (220) is disposed on the outermost layer in the direction through which air passes (the uppermost end of the filter medium, see FIG. 3), it is possible to remove even small particles by applying an electrostatic force to increase the dust collection efficiency. Specifically, in the filter medium, dust is first adsorbed by applying an electrostatic force to the polypropylene-based melt-blown layer (220), and particulate contaminants containing dust or oil are secondarily removed by the porous layer (210), whereby it is possible to enhance the durability of the filter medium. In particular, in the composite filter medium according to the embodiment of the present invention in which the filter medium comprises the polypropylene-based melt-blown layer (220) and the porous layer (210), the efficiency of removing pollutants and life span characteristics can be further enhanced since it has a composite structure with the porous layer (210) even when the performance of the polypropylene-based melt-blown layer (220) is decreased as the temperature is raised.

The polypropylene-based melt-blown layer may have a basis weight of, for example, 20 gsm to 40 gsm, for example, 20 gsm to 35 gsm, or, for example, 25 gsm to 35 gsm.

If the basis weight of the polypropylene-based melt-blown layer is less than 20 gsm, it may be difficult to achieve a high efficiency particulate air (HEPA) rating, or the durability may not be sufficient. If the basis weight of the polypropylene-based melt-blown layer exceeds 40 gsm, it may be difficult to be bent when a filter is manufactured.

Meanwhile, the polypropylene-based melt-blown layer (220) may comprise polypropylene having a melt index of 800 g/10 minutes to 1,500 g/10 minutes at 265° C. Specifically, the polypropylene may have a melt index of, for example, 900 g/10 minutes to 1,200 g/10 minutes at 265° C., or, for example, 950 g/10 minutes to 1,200 g/10 minutes. If polypropylene having a melt index in the above range is employed, there may be an advantage that the workability at low temperatures and productivity are enhanced.

The polypropylene-based melt-blown layer (220) has a most penetrated particle size of 80% or more, 85% or more, 88% or more, 89% or more, or 90% or more, as measured by air permeation at a flow rate of 5.3 cm/second using NaCl having a particle size of 0.05 to 1 pun. In addition, the most penetrated particle size of the polypropylene-based melt-blown layer may be 99.95% or less, 99.92% or less, or 99.90% or less.

Process for Manufacturing a Filter Medium

The process for manufacturing a filter medium according to an embodiment of the present invention comprises a first step of laminating a first polyester-based nonwoven fabric layer (230a) and a second polyester nonwoven fabric layer (230b) on the lower and upper sides of a porous layer (210), respectively; and a second step of laminating a polypropylene-based melt-blown layer (220) on the upper side of the second non-woven fabric layer (230b).

Hereinafter, the process for manufacturing a filter medium according to an embodiment of the present invention will be described in detail for each step.

In the process for manufacturing a filter medium of the present invention, the first step comprises laminating a first polyester-based nonwoven fabric layer (230a) and a second polyester nonwoven fabric layer (230b) on the lower and upper sides of a porous layer (210), respectively.

Lamination of the first and second nonwoven fabric layers (230a and 230b) on the upper and lower sides of the porous layer (210) may be carried out at a temperature of 70 to 90° C. Specifically, the lamination may be carried out at 75 to 90° C., 75 to 85° C., or 78 to 85° C. The lamination may be carried out using a hot melt adhesive or heat.

When a hot melt adhesive is used, the amount of the hot melt adhesive may be 1 gsm to 10 gsm, 2 gsm to 10 gsm, or 3 gsm to 8 gsm. If the hot melt adhesive is used in the above range, adhesion may be enhanced.

According to an embodiment of the present invention, the filter medium comprises PET as the first and second nonwoven fabric layers (230a and 230b), so that adhesion between the respective constituent layers may be enhanced by the hot melt adhesive alone.

In the process for manufacturing a filter medium of the present invention, the second step comprises laminating a polypropylene-based melt-blown layer (220) on the upper side of the second non-woven fabric layer (230b).

Lamination of the polypropylene-based melt-blown layer (220) on the upper side of the second nonwoven fabric layer may be carried out using a hot melt adhesive. The lamination temperature and the amount of the hot melt adhesive used may be the same as those described in the first step.

Process for Manufacturing a Dust Collecting Filter

A process for manufacturing a dust collecting filter may be provided using the filter medium according to an embodiment of the present invention.

The process for manufacturing a dust collecting filter comprises a first step of laminating a first polyester-based nonwoven fabric layer and a second polyester nonwoven fabric layer on the lower and upper sides of a porous layer, respectively; and a second step of laminating a polypropylene-based melt-blown layer on the upper side of the second non-woven fabric layer, wherein the porous layer comprises a polytetrafluoroethylene (PTFE) resin, the first nonwoven fabric layer and the second nonwoven fabric layer comprise polyethylene terephthalate (PET), the melt-blown layer comprises polypropylene having a melt index of 800 g/10 minutes to 1,500 g/10 minutes at 265° C., the sum of the basis weights of the first nonwoven fabric layer and the second nonwoven fabric layer is 35 gsm to 85 gsm, and the basis weight of the melt-blown layer is 20 gsm to 40 gsm.

Referring to FIG. 1 again, the process for manufacturing a dust collecting filter according to an embodiment of the present invention may further comprise mounting the filter medium (200) in the housing (300) using a molding machine.

Specifically, the filter medium (200) may be insert molded into the housing (300) by using a molding machine and using the housing (300) as a support frame.

In addition, before the filter medium (200) is molded, it may be processed into a pleated shape, for example, using a rotary pleating machine. In such event, the shape of pleats, the height of the peaks of the pleats, and the distance between the peaks are as described above.

In addition, the filter medium (200) may be insert molded into the housing (300) by using a molding machine and using the housing (300) as a support frame without being subjected to the pleating process.

In addition, the filter medium (200) may be bent to filter a large area. That is, the filter medium may be formed as bent in the dust collecting filter. The bending may be performed in a zigzag manner

Properties of the Dust Collecting Filter

The dust collecting filter according to an embodiment of the present invention can simultaneously satisfy high performance and high life span characteristics while it maintains a high efficiency of removing particulate pollutants in the air.

In general, the life span of a dust collecting filter and the differential pressure of the filter are highly affected by each other. The differential pressure of a filter means the difference in pressure between the upstream and the downstream of the filter medium. When a fluid containing contaminated particles passes through a filter, the particles are collected in the pores of the filter to clog the pores. When the pores are clogged, it gradually increases the pressure. That is, the differential pressure of a filter is gradually increased as time passes or as particles are collected in the filter. Thus, the differential pressure of a dust collecting filter is a main factor that determines the replacement timing of the filter and may be a measure for determining the life span of the filter.

In particular, the difference in the differential pressure with respect to the amount of particles collected in the filter is very important in the dust collecting filter. If the difference in the differential pressure is too small with respect to the amount of particles collected in the filter, the performance of removing dust may be deteriorated. If the difference in the differential pressure is too large with respect to the amount of particles collected in the filter, the life span of the filter may be shortened and the power consumption may be increased. Thus, to have a difference in the differential pressure in an appropriate range with respect to the amount of particles collected in a filter may be very advantageous for satisfying high performance, low power consumption, and high life span characteristics of the filter at the same time.

The dust collecting filter according to an embodiment of the present invention may satisfy the following Relationship 1 in which the differential pressure is PI₁₀ when the amount of dust supplied (DF) based on a flow rate of 1 m/s is 10 g (DF₁₀), and the differential pressure is PI₄₀ when the amount of dust supplied (DF) is 40 g (DF₄₀):

1.00≤(PI₄₀−PI₁₀) (Pa)/(DF₄₀−DF₁₀) (g)≤2.75. <Relationship 1>

Relationship 1 represents the difference in the differential pressure (PI₄₀ −PI₁₀) with respect to the change in the amount of dust supplied (DF₄₀ −DF₁₀). The ratio (Pa/g) of the difference in the differential pressure (PI₄₀ −PI₁₀) to the change in the amount of dust supplied (DF₄₀−DF₁₀) may be, for example, 1.20 to 2.70, 1.50 to 2.50, or 1.80 to 2.30.

If the range of Relationship 1 is less than 1.00, there may be a problem from the viewpoint of the performance of removing dust. If the range of Relationship 1 exceeds 2.75, the differential pressure may be increased excessively, thereby shortening the life span of the filter and increasing the power consumption. Thus, if the filter satisfies the above range, the difference in the differential pressure with respect to the amount of dust supplied may be maintained within an appropriate range, thereby enabling a long-term operation and enhancing the life span characteristics of the filter.

In addition, the difference between PI₁₀ and PI₀ (PI₁₀−PI₀) in which the differential pressure is PI₀ when the amount of dust supplied (DF) is 0 g (DF₀) may be 8 Pa to 10 Pa, 8 Pa to 9.5 Pa, 8.2 Pa to 9.2 Pa, 8.5 Pa to 9.2 Pa, or 8.5 Pa to 9 Pa. If the difference between PI₁₀ and PI₀ is less than 8 Pa, there may be a problem from the viewpoint of the performance of removing dust. If it exceeds 10 Pa, the differential pressure may be increased excessively, thereby shortening the life span of the filter and increasing the power consumption.

In addition, the difference between PI₄₀ and PI₀ (PI₄₀−PI₀) may be 50 Pa to 90 Pa, 50 Pa to 80 Pa, 50 Pa to 75 Pa, 55 Pa to 75 Pa, or 60 Pa to 75 Pa. If the difference between PI₄₀ and PI₀ is less than 50 Pa, there may be a problem from the viewpoint of the performance of removing dust. If it exceeds 90 Pa, the differential pressure may be increased excessively, thereby shortening the life span of the filter and increasing the power consumption.

Here, the differential pressure is measured while supplying ISO A2 dust (test microparticles) at a flow rate of 1 m/s using a Topas PAF-113-cabin filter test system. When the differential pressure of the filter is measured as the ISO A2 dust accumulates, the lower the differential pressure, the better the life span of the filter and the lesser the power consumption. In addition, if the difference in the differential pressure is within an appropriate range as dust accumulates, it is possible to enhance the performance and life span of the filter as well as to reduce the power consumption.

The PI₀ may be 30 Pa to 80 Pa, 35 Pa to 75 Pa, 40 Pa to 75 Pa, 45 Pa to 75 Pa, or 60 Pa to 75 Pa.

The PI₁₀ may be 38 Pa to 90 Pa, 42 Pa to 85 Pa, 55 Pa to 80 Pa, 60 Pa to 80 Pa, or 70 Pa to 80 Pa.

The PI₄₀ may be 80 Pa to 160 Pa, 90 Pa to 150 Pa, 110 Pa to 145 Pa, 125 Pa to 142 Pa, or 130 Pa to 140 Pa.

If the PI₀, PI₁₀, or PI₄₀ satisfies the above range and the range of Relationship 1, it may be more advantageous for achieving the desired effect in the present invention.

The dust collecting filter according to an embodiment of the present invention may have an excellent dust collection efficiency measured using diethylhexyl sebacate (DEHS). Specifically, it may be 99% or more, 99.5% or more, 99.6% or more, 99.7% or more, or 99.8% or more.

The dust collection efficiency indicates the percentage (%) of the amount of particulate matter to be collected relative to the amount of particulate matter supplied to the filter. The dust collection efficiency is measured while supplying diethylhexyl sebacate (DEHS) at a flow rate of 1 m/s using a Topas PAF-113-cabin filter test system. In the dust collecting filter according to an embodiment of the present invention, it is preferable to maintain the dust collection efficiency of the filter to be uniform regardless of the accumulated amount of DEHS.

In addition, the variation in the dust collection efficiency of DEHS may be 5% or less, 4% or less, 3% or less, 2% or less, 1% or less, 0.5% or less, 0.3% or less, 0.2% or less, or 0.16% or less, when the amount of DEHS supplied is in the range of 0 g to 60 g.

Specifically, the dust collection efficiency of DEHS may be 99.5% or more, 99.6% or more, 99.7% or more, 99.8% or more, or 99.9% or more, when the amount of DEHS supplied is 0 g.

The dust collection efficiency of DEHS may be 99% or more, 99.5% or more, 99.6% or more, 99.7% or more, or 99.8% or more, when the amount of DEHS supplied is 60 g.

### EMBODIMENTS FOR CARRYING OUT THE INVENTION

Hereinafter, the present invention is explained in detail by the following Examples. However, these examples are provided only for illustration purposes, and the present invention is not limited thereto.

### Example 1

<Manufacture of a Filter Medium>

First step: laminating a first polyester-based nonwoven fabric layer (230a) and a second polyester nonwoven fabric layer (230b) on the lower and upper sides of a porous layer (210), respectively

First and second polyethylene terephthalate (PET) of 30 gsm was laminated by a hot melt adhesive on the lower and upper sides of PTFE having a thickness of about 2 μm and a porosity of about 50%, respectively, to form a first nonwoven fabric layer and a second nonwoven fabric layer on the lower and upper sides of PTFE. In such event, the lamination temperature was about 80° C., and the amount of the hot melt adhesive was about 5 gsm.

Second step: laminating a polypropylene-based melt-blown layer (220) on the upper side of the second non-woven fabric layer (230b)

A polypropylene-based melt-blown layer (220) (CNTUS-SUNGJIN/1125) of 25 gsm was laminated on the upper side of the second non-woven fabric layer by a hot melt adhesive to form a polypropylene-based melt-blown layer on the upper side of the second non-woven fabric layer, thereby obtaining a 4-layer filter medium. In such event, the lamination temperature was about 80° C., and the amount of the hot melt adhesive was about 5 gsm.

<Manufacture of a Dust Collecting Filter>

The filter medium was pleated using a rotary pleating machine (DBWP-W700, DoubleWin) to have a peak height of 25 mm and a distance between peaks of about 3.5 mm of the pleats. Upon completion of the pleat processing, the filter medium was insert molded into an ABS housing using a molding machine (Filter Assy M/C, DoubleWin) to manufacture a dust collecting filter.

### Examples 2 to 5

The same method as in Example 1 was carried out to obtain a 4-layer filter medium and a dust collecting filter comprising it, except that the basis weight of the first and second PET in the first step of Example 1 was adjusted as shown in Table 1 below.

### Example 6

The same method as in Example 1 was carried out to obtain a 4-layer filter medium and a dust collecting filter comprising it, except that the basis weight of the polypropylene-based melt-blown layer in the second step of Example 1 was adjusted as shown in Table 1 below.

### Comparative Example 1

A polypropylene-based melt-blown layer of 25 gsm was used to manufacture a one-layer melt-blown filter medium and a dust collecting filter comprising it.

### Comparative Example 2

The same method as in Example 1 was carried out to obtain a 3-layer filter medium and a dust collecting filter comprising it, except that only the first step of Example 1 was carried out while a polypropylene-based melt-blown layer was not formed.

### Comparative Examples 3 to 6

The same method as in Example 1 was carried out to obtain a 4-layer filter medium and a dust collecting filter comprising it, except that the basis weight of the first nonwoven fabric layer, the second nonwoven fabric layer, and/or the polypropylene-based melt-blown layer was adjusted as shown in Table 1 below.

TABLE 1

| | Configuration of the filter medium | | | | | |
|---|---|---|---|---|---|---|
| | | | | | Melt-blown | |
| | | First and second nonwoven fabric layers | | | (MB) | |
| | | | | First and | layer | |
| | Porous | | | second PET | Basis | |
| | layer | First | Second | Sum of the | weight of | |
| | PTFE | PET | PET | basis | the MB | No. of |
| | (μm) | (μm) | (μm) | weights | (gsm) | laminations |
| Ex. 1 | 2 | 30 | 30 | 60 | 25 | 4 |
| Ex. 2 | 2 | 20 | 30 | 50 | 25 | 4 |
| Ex. 3 | 2 | 20 | 20 | 40 | 25 | 4 |
| Ex. 4 | 2 | 20 | 50 | 70 | 25 | 4 |
| Ex. 5 | 2 | 60 | 20 | 80 | 25 | 4 |
| Ex. 6 | 2 | 30 | 30 | 60 | 35 | 4 |
| C. Ex. 1 | — | — | — | — | 25 | 1 |
| C. Ex. 2 | 2 | 30 | 30 | 60 | — | 3 |
| C. Ex. 3 | 2 | 70 | 20 | 90 | 25 | 4 |
| C. Ex. 4 | 2 | 10 | 20 | 30 | 25 | 4 |
| C. Ex. 5 | 2 | 30 | 30 | 60 | 15 | 4 |
| C. Ex. 6 | 2 | 30 | 30 | 60 | 45 | 4 |

### Test Example

(1) Measurement of Differential Pressure

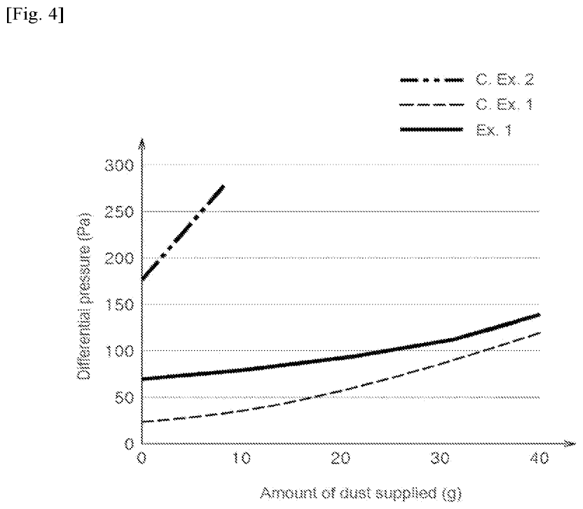

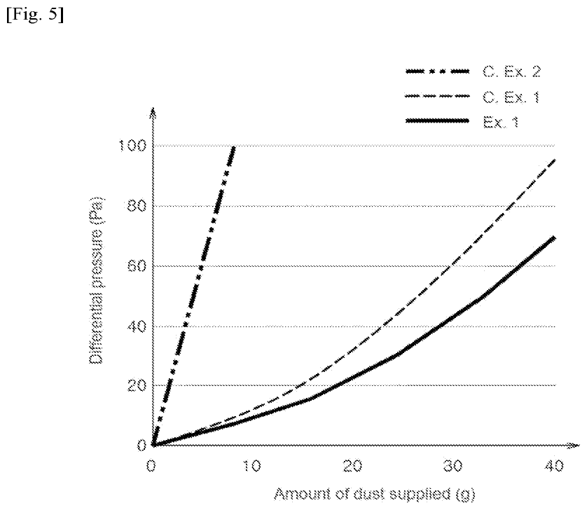

The differential pressure was measured while supplying ISO A2 dust (dust) at a flow rate of 1 m/s using a Topas PAF-113-cabin filter test system. The differential pressure of the filter thus measured with respect to the amount of dust supplied is shown in FIGS. 4 and 5.

(2) Measurement of Dust Collection Efficiency

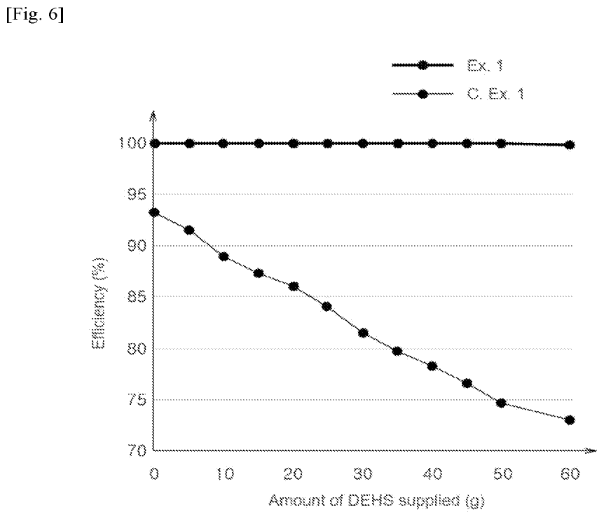

The dust collection efficiency was measured while supplying diethylhexyl sebacate (DEHS) and ISO A2 dust in an amount of 0 to 60 g at a flow rate of 1 m/s using a Topas PAF-113-cabin filter test system. The dust collection efficiency of the filter thus measured is shown in FIG. 6.

(3) Measurement of Bendability

It was determined based on the bendability during manufacture.
Manufactured as bent: ∘
Not manufactured as bent: x

(4) Measurement of Durability

The durability of the filter was evaluated by measuring the dust holding capacity. The DHC was based on the time when the performance change occurred within 50% of the initial pressure loss when 40 g of ISO A2 particles were loaded.
Pressure loss of less than 50%: ∘
Pressure loss of 50% or more: x

(5) Measurement of Filter Sustainability

The supportability and sustainability of the filter was measured while supplying air at a flow rate of 1 m/s using a Topas PAF-113-cabin filter test system.
Supported and sustained (the difference in pressure loss being determined): ∘
Not supported or sustained: x

TABLE 2

| | Bendability | Durability | Filter sustainability |
|---|---|---|---|
| Ex. 1 | ∘ | ∘ | ∘ |
| Ex. 2 | ∘ | ∘ | ∘ |
| Ex. 3 | ∘ | ∘ | ∘ |
| Ex. 4 | ∘ | ∘ | ∘ |
| Ex. 5 | ∘ | ∘ | ∘ |
| Ex. 6 | ∘ | ∘ | ∘ |
| C. Ex. 1 | x | ∘ | x |
| C. Ex. 2 | ∘ | x | ∘ |
| C. Ex. 3 | x | ∘ | ∘ |
| C. Ex. 4 | x | ∘ | x |
| C. Ex. 5 | x | ∘ | ∘ |
| C. Ex. 6 | ∘ | x | ∘ |

As can be seen from Table 2 above, in Examples 1 to 6 according to an embodiment of the present invention, the bendability, durability, and filter sustainability were all improved as compared with Comparative Examples 1 to 6.

As can be seen from Table 2 above, in Examples 1 to 6 in which the filter medium was formed as a first nonwoven fabric layer, a porous layer, a second nonwoven fabric layer, and a melt-blown layer were sequentially laminated, the sum of the basis weights of the first nonwoven fabric layer and the second nonwoven fabric layer was in the range of 35 gsm to 85 gsm, and the basis weight of the melt-blown layer was in the range of 20 gsm to 40 gsm, the dust collecting filter was excellent in all of bendability, durability, and filter sustainability.

In contrast, in Comparative Example 1 in which the filter medium was composed of a melt-blown layer alone, the bendability and filter sustainability of the dust collecting filter was decreased. In Comparative Example 2 in which the filter medium was formed as three layers of a first non-woven fabric layer, a porous layer, and a second non-woven fabric layer were sequentially laminated without a melt-blown layer, the durability of the dust collecting filter was decreased although its bendability and filter sustainability were good.

Meanwhile, although the filter medium was formed as a first nonwoven fabric layer, a porous layer, a second nonwoven fabric layer, and a melt-blown layer were sequentially laminated as in Examples 1 to 6, the bendability of the dust collecting filter was decreased in Comparative Example 3 in which the sum of the basis weights of the first nonwoven fabric layer and the second nonwoven fabric layer was excessively large as 90 gsm; and the bendability and filter sustainability of the dust collecting filter were decreased in Comparative Example 4 in which the sum of the basis weights of the first nonwoven fabric layer and the second nonwoven fabric layer was excessively small as 30 gsm.

Further, although the filter medium comprised 4 layers while satisfying the sum of the basis weights of the first nonwoven fabric layer and the second nonwoven fabric layer, the bendability of the dust collecting filter was decreased in Comparative Example 5 in which the basis weight of the melt-blown layer was as small as 15 gsm; and the durability of the dust collecting filter was decreased in Comparative Example 6 in which the basis weight of the melt-blown layer was excessively large as 45 gsm.

Meanwhile, FIG. 4 is a graph showing the differential pressure with respect to the amount of dust supplied; and FIG. 5 is a graph showing the difference in differential pressure with respect to the amount of dust supplied.

As can be seen from FIGS. 4 and 5, as a result of measuring the differential pressure while supplying ISO A2 dust at a flow rate of 1 m/s, the dust collecting filter of Example 1 showed a curve in which the difference in the differential pressure with respect to the accumulation amount of ISO A2 dust was gentler as compared with the dust collecting filters of Comparative Examples 1 and 2.

Specifically, in Example 1, the initial differential pressure of the dust collecting filter was higher than that of the dust collecting filter of Comparative Example 1 composed of the melt blown layer alone, whereas the difference (PI₁₀−PI₀) between the differential pressure (PI₁₀) when the amount of ISO A2 dust supplied was 10 g and the differential pressure (PI₀) when the amount of ISO A2 dust supplied was 0 g was about 8.77 Pa, the difference (PI₄₀−PI₀) between the differential pressure (PI₄₀) when the amount of ISO A2 dust supplied was 40 g and the differential pressure (PI₀) when the amount of ISO A2 dust supplied was 0 g was about 69 Pa, and the value of (PI₄₀−PI₁₀) (Pa)/(DF₄₀−DF₁₀) (g) in Relationship 1 was about 2.

In contrast, in Comparative Example 1, the initial differential pressure of the dust collecting filter was lower than that of the dust collecting filter of Example 1, whereas PI₁₀−PI₀ was about 11.29 Pa, PI₄₀−PI₀ was about 94.4 Pa, the value of (PI₄₀−PI₁₀) (Pa)/(DF₄₀−DF₁₀) (g) in Relationship 1 was about 2.77, so that the variation in the differential pressure of the dust collecting filter with respect to the amount of ISO A2 dust supplied (or the amount of dust supplied) was increased as compared with Example 1.

Meanwhile, in the dust collecting filter of Comparative Example 2, the filter medium had poor bendability and filter sustainability, so that the differential pressure of the filter with respect to the amount of dust supplied could not be measured.

Thus, the difference in the differential pressure with respect to the amount of dust supplied was kept low at an appropriate level in the dust collecting filter of Example 1 as compared with the dust collecting filter of Comparative Example 1, so that the performance of removing dust and the life span characteristics of the filter may be further enhanced.

In addition, as confirmed from FIG. 6, as a result of measuring the dust collection efficiency while supplying DEHS at a flow rate of 1 m/s, the filter of Example 1 maintained the dust collection efficiency of the filter to be uniform regardless of the accumulated amount of DEHS.

Specifically, the filter of Example 1 showed a dust collection efficiency of about 99.97% when the amount of DEHS supplied was 0 g, a dust collection efficiency of about 99.84% when the amount of DEHS supplied was 30 g, and a dust collection efficiency of about 99.81% when the amount of DEHS supplied was about 60 g. Thus, the variation in the dust collection efficiency was about 0.16% in the range of 0 g to 60 g, showing that the dust collection efficiency of the filter was uniform regardless of the accumulated amount of DEHS.

In contrast, the variation in the dust collection efficiency was about 20% or more when the amount of DEHS supplied was in the range of 0 g to 60 g, showing that the dust collection efficiency significantly varied.

### EXPLANATION OF REFERENCE NUMERALS

100: dust collecting filter
200: filter medium
300: housing
210: porous layer
220: polypropylene-based melt-blown layer
230a: first nonwoven fabric layer
230b: second nonwoven fabric layer
A-A′: cutting line
B-B′: cutting line

1. A dust collecting filter formed by bending a filter medium, wherein the filter medium comprises:
a first polyester-based nonwoven fabric layer;
a porous layer disposed on the upper side of the first nonwoven fabric layer;
a second polyester-based nonwoven fabric layer disposed on the upper side of the porous layer; and
a polypropylene-based melt-blown layer disposed on the upper side of the second nonwoven fabric layer,
the porous layer comprises a polytetrafluoroethylene (PTFE) resin,
the first nonwoven fabric layer and the second nonwoven fabric layer comprise polyethylene terephthalate (PET),
the melt-blown layer comprises polypropylene having a melt index of 800 g/10 minutes to 1,500 g/10 minutes at 265° C.,
the sum of the basis weights of the first nonwoven fabric layer and the second nonwoven fabric layer is 35 gsm to 85 gsm, and
the basis weight of the melt-blown layer is 20 gsm to 40 gsm.

2. The dust collecting filter of claim 1, which satisfies the following Relationship 1 in which the differential pressure is PI₁₀ when the amount of dust supplied (DF) based on a flow rate of 1 m/s is 10 g (DF₁₀), and the differential pressure is PI₄₀ when the amount of dust supplied (DF) is 40 g (DF₄₀):
1.00≤(PI₄₀−PI₁₀) (Pa)/(DF₄₀−DF₁₀) (g)≤2.75. <Relationship 1>

3. The dust collecting filter of claim 2, wherein the difference between PI₁₀ and PI₀ (PI₁₀−PI₀) is 8 Pa to 10 Pa, and the difference between PI₄₀ and PI₀ (PI₄₀ −PI₀) is 50 Pa to 90 Pa, in which the differential pressure is PI₀ when the amount of dust supplied (DF) is 0 g (DF₀).

4. The dust collecting filter of claim 1, which has a dust collection efficiency of 99% or more when measured using diethylhexyl sebacate (DEHS).

5. The dust collecting filter of claim 4, wherein the variation in the dust collection efficiency of DEHS is 5% or less when the amount of DEHS supplied is in the range of 0 g to 60 g.

6. A process for manufacturing a dust collecting filter, which comprises:
a first step of laminating a first polyester-based nonwoven fabric layer and a second polyester nonwoven fabric layer on the lower and upper sides of a porous layer, respectively; and
a second step of laminating a polypropylene-based melt-blown layer on the upper side of the second non-woven fabric layer,
wherein the porous layer comprises a polytetrafluoroethylene (PTFE) resin,
the first nonwoven fabric layer and the second nonwoven fabric layer comprise polyethylene terephthalate (PET),
the melt-blown layer comprises polypropylene having a melt index of 800 g/10 minutes to 1,500 g/10 minutes at 265° C.,
the sum of the basis weights of the first nonwoven fabric layer and the second nonwoven fabric layer is 35 gsm to 85 gsm, and
the basis weight of the melt-blown layer is 20 gsm to 40 gsm.

7. The process for manufacturing a dust collecting filter of claim 6, wherein the first step is carried out at a temperature of 70 to 90° C., and the second step is carried out using a hot melt adhesive.
